(19) United States
(12) Patent Application Publication
(10) Pub. No.: US 2025/0365659 A1
(43) Pub. Date: Nov. 27, 2025

(54) BASE STATION ENERGY SAVING MANAGEMENT DEVICE AND METHOD

(71) Applicant: ELECTRONICS AND TELECOMMUNICATIONS RESEARCH INSTITUTE, Daejeon (KR)

(72) Inventors: Sung Kyung Kim, Daejeon (KR); JeeHyeon Na, Daejeon (KR)

(21) Appl. No.: 19/209,481

(22) Filed: May 15, 2025

(30) Foreign Application Priority Data
May 24, 2024 (KR) 10-2024-0067761

(51) Int. Cl. H04W 52/02; H04W 36/22

(52) U.S. Cl. CPC H04W 52/0203; H04W 36/22

(57) ABSTRACT

Provided herein is a base station device which includes a communication module configured to provide a communication channel to a capacity booster cell overlapping some region of at least one adjacent cell, and a processor functionally connected to the communication module, wherein the processor may receive cell load information and channel information from the at least one adjacent cell and at least one terminal within the capacity booster cell through the communication module; confirm that the capacity booster cell satisfies a first condition according to the cell load information and the channel information, in which the first condition is that a load of the capacity booster cell is less than a specified threshold value, and a specified terminal is not located within the capacity booster cell; and switch to an energy saving mode when the capacity booster cell satisfies the first condition.

### CROSS-REFERENCE TO RELATED APPLICATION

This application claims priority to and the benefit of Korean Patent Application No. 10-2024-0067761, filed on Mar. 24, 2024, the disclosure of which is incorporated herein by reference in its entirety.

### BACKGROUND

### 1. Field of the Invention

Various embodiments of the present disclosure relate to a base station power management technology.

### 2. Discussion of Related Art

In modern society where resource depletion and environmental destruction are serious, energy saving is a very important topic. Thus, various energy reduction technologies are also being applied to mobile communication systems.

For example, a 3^{rd} Generation Partnership Project (3GPP) standard for mobile communication systems supports energy saving by defining an idle duration during which a terminal does not transmit or receive signals (does not use power) during a discontinuous reception (DRX) cycle and a time duration during which signal transmission and reception are ensured.

As a way to save energy at a base station, an energy saving function is provided that a specific cell (or a base station of the corresponding cell) is powered off depending on a user distribution or a traffic load. This is because, in an environment in which cells are highly dense, terminal distribution and data demand situations change, and a case in which a base station is always activated can be inefficient in terms of energy saving.

### SUMMARY OF THE INVENTION

However, it is difficult to determine when to power on a cell in a power-off state (or an energy saving mode) again.

Various embodiments of the present disclosure may provide a base station energy saving management device and method capable of adaptively managing base station energy saving according to channel conditions.

A booster base station for managing a capacity booster cell for increasing a communication channel in some region of at least one adjacent cell according to one embodiment of the present invention includes a communication module configured to provide a communication channel to the capacity booster cell overlapping the some region, and a processor functionally connected to the communication module, wherein the processor may receive cell load information and channel information from the at least one adjacent cell and at least one terminal within the capacity booster cell through the communication module; confirm that the capacity booster cell satisfies a first condition according to the cell load information and the channel information, in which the first condition is that a load of the capacity booster cell is less than a specified threshold value, and a specified terminal is not located within the capacity booster cell; and switch to an energy saving mode when the capacity booster cell satisfies the first condition.

A base station energy saving method of managing a capacity booster cell for increasing a communication channel in some region of at least one adjacent cell according to one embodiment of the present invention includes receiving cell load information and channel information from the at least one adjacent cell and at least one terminal within the capacity booster cell; confirming that the capacity booster cell satisfies a first condition according to the cell load information and the channel information, wherein the first condition is that a load of the capacity booster cell is less than a specified threshold value, and a specified terminal is not located within the capacity booster cell; and when it is confirmed that the capacity booster cell satisfies the first condition, switching the capacity booster cell to an energy saving mode.

A base station device for managing a candidate cell of which some region overlaps a capacity booster cell for increasing a communication channel according to one embodiment of the present invention includes a communication module configured to provide a communication channel in the candidate cell, and a processor functionally connected to the communication module, wherein the processor may calculate a load in the candidate cell through the communication module, confirm whether the capacity booster cell overlapping the some region of the candidate cell is in an energy saving mode when the load in the candidate cell is greater than or equal to a specified threshold value, and transmit a cell activation request to a base station of the capacity booster cell when a specified terminal is located within the capacity booster cell.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram for describing an energy saving(ES) probing process of a mobile communication system according to one embodiment;

FIG. 2 is an exemplary diagram illustrating a mobile communication system (e.g., a 3^{rd} Generation Partnership Project (3GPP) 5G-New Radio (NR) system) including a plurality of capacity booster cells and a plurality of candidate cells according to one embodiment;

FIG. 3 is a flowchart illustrating a distributed ES activation process according to one embodiment;

FIG. 4 is a flowchart illustrating a distributed ES deactivation process according to one embodiment;

FIG. 5 is a block diagram illustrating a base station device according to one embodiment;

FIG. 6 is a flowchart illustrating a base station power management method according to one embodiment;

FIG. 7 is a flowchart illustrating a method of entering an energy saving mode according to one embodiment;

FIG. 8 is a flowchart illustrating a method of deactivating an energy saving mode according to one embodiment;

FIG. 9 is a block diagram illustrating a candidate cell base station device according to one embodiment; and

FIG. 10 is a flowchart illustrating a power management method by a candidate cell base station according to one embodiment.

In relation to the description of the drawings, identical or similar reference numerals may be used for identical or similar components.

### DETAILED DESCRIPTION OF EXEMPLARY EMBODIMENTS

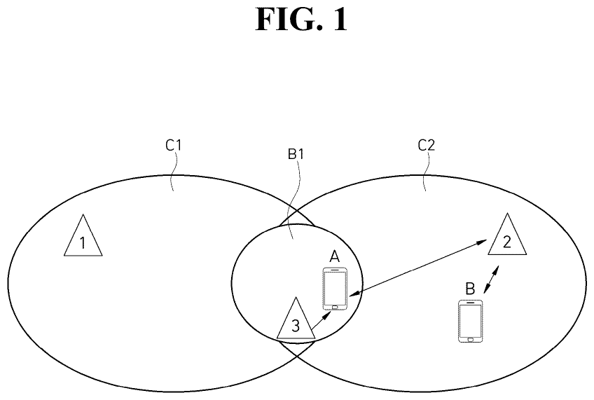

FIG. 1 is a diagram for describing an energy saving (hereinafter used interchangeably with “ES”) probing process of a mobile communication system according to one embodiment.

Referring to FIG. 1, a mobile communication system may include capacity booster cell BC1 and candidate cells CC1 and CC2 (or coverage cells) according to the definition of the 3^{rd} Generation Partnership Project (3GPP) standard for energy saving. The capacity booster cell BC1 is a hot spot cell for the purpose of increasing a capacity, and the capacity booster cell BC1 may be managed by a booster base station 3. The candidate cells CC1 and CC2 are cells including at least a part of coverage of the capacity booster cell BC1 and compensate for the coverage of the capacity booster cell BC1 when the capacity booster cell BC1 is in an energy saving mode (energy saving state). The candidate cells CC1 and CC2 may be managed by candidate cell base stations 1 and 2.

When a load of each of the candidate cells CC1 and CC2 is an individual threshold value or less, the capacity booster cell BC1 is switched to the energy saving mode. For example, when loads of the capacity booster cell BC1 and the candidate cells CC1 and CC2 remain at threshold values for a specified period of time, the booster base station 3 may attempt to enter the energy saving mode (or power off the capacity booster cell BC1). In addition, when the loads within candidate cells CC1 and CC2 increase, the candidate cell base stations 1 and 2 may request the booster base station 3 to reactivate the capacity booster cell BC1 which is in the energy saving mode. The specified period of time may be set according to, for example, the 3GPP 5G-New Radio (NR) standard.

However, since a moving path of a terminal or traffic requirements change immediately, the reactivation request may be received shortly after a power off time point of the capacity booster cell BC1. An ES ping pong phenomenon, in which switching between the energy saving mode (ES activation state) and a cell activation mode (active state) (ES deactivation state) is excessively frequent, may actually increase power consumption.

Referring to FIG. 1, it is assumed that the capacity booster cell BC1 is in the energy saving mode and the second candidate cell CC2 is connected to a terminal A and a terminal B.

The booster base station 3 may detect that the terminal A is present within its coverage area through an ES probing process in which minimum broadcast information is transmitted for a certain period of time in the energy saving mode. However, if the terminal A, which is moving, stays within the capacity booster cell BC1 for a short period of time, when the capacity booster cell BC1 is activated for communication of the terminal A, the capacity booster cell BC1 should be changed back to the energy saving mode according to the movement of the terminal A (i.e., the ES ping pong phenomenon occurs). Therefore, when a quality of service level (QoS level) of the terminal A is not high, it is advantageous in terms of energy efficiency to support communication of the terminal B by the second candidate cell CC2. In other words, the second candidate cell CC2 should support communication of the terminal A and maintain the capacity booster cell BC1 in the energy saving mode to further save energy.

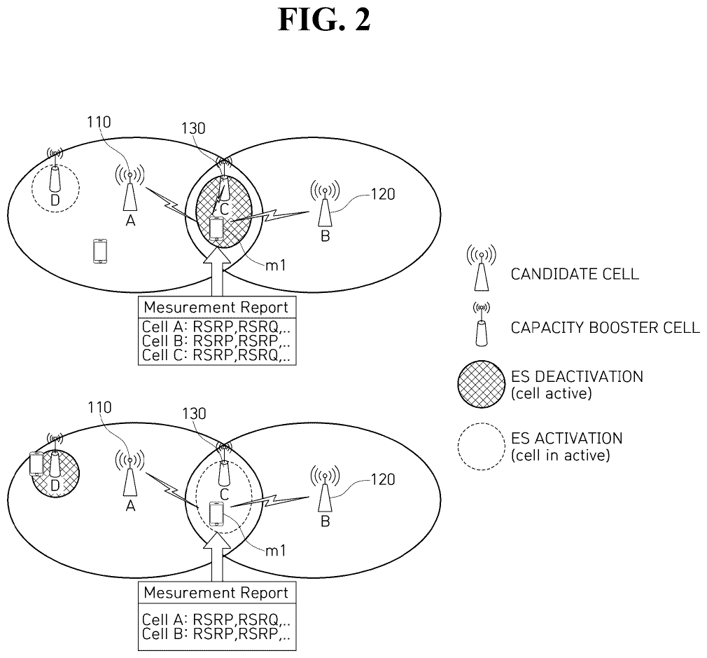

FIG. 2 is an exemplary diagram illustrating a mobile communication system (e.g., a 3GPP 5G NR system) including a plurality of capacity booster cells and a plurality of candidate cells according to one embodiment. FIG. 2 shows an example of arrangement of terminals and candidate cells in a case (A) in which the capacity booster cell C is in a cell activation mode (ES deactivation state) and a case (B) in which the capacity booster cell C is in the energy saving mode (ES activation state).

According to the 3GPP 5G NR standard, the capacity booster cell C may request periodic load information (Resource State) from candidate cells A and B. For example, the booster base station 130 managing the capacity booster cell C may transmit a load information request (Resource State Request) including measurement information and a reporting cycle, which are to be requested, to a candidate cell base station (e.g., 120). When the candidate cell base station (e.g., 120) receives the load information request, the candidate cell base station may measure a load of the candidate cell (e.g., PRB Usage). The candidate cell base station (e.g., 120) may transmit a load information response (Resource State Response) regarding the measured load. Alternatively, when the load measurement fails, the candidate cell base station (e.g., 120) may transmit a load measurement failure response (Resource Status Failure). The candidate cell base station (e.g., 120) may transmit measurement information through a load information update (Resource Status Update) message. In this case, when a periodic reporting request (Reporting Periodicity IE) is received, the candidate cell base station (e.g., 120) may periodically transmit the measurement information to the booster base station 130.

According to an embodiment, the booster base station 130 collects channel information of a terminal within the capacity booster cell C in an activation duration of the capacity booster cell C to predict a location of the terminal within the corresponding cell. The channel information may include at least one of reference signal received power (RSRP), reference signal received quality (RSRQ), and a signal interference noise ratio (SINR) of a serving cell and adjacent cells. For example, referring to the case (A) of FIG. 2, when the capacity booster cell C is in the cell activation mode, a terminal ml included in a radio coverage of the capacity booster cell C may measure RSRP of adjacent cells (including the serving cell C) A, B, and C and report a measurement report to the booster base station 130. In order to identify a location of the terminal ml (e.g., whether the terminal enters a radio coverage of the cell C) the booster base station 130 stores and manages RSRP information. As the RSRP becomes higher, the terminal ml may receive a signal well from each base station.

In addition, the booster base station 130 may also manage terminal information around the candidate cells by tracing channel information of a terminal being handed over from the candidate cells (e.g., the cell B and the cell C).

According to an embodiment, when an overall network load is a specified total threshold value or less and a load (e.g., a physical resource block (PRB) occupation ratio (PRB Usage)) of a capacity booster cell (e.g., the cell C) is an individual threshold value or less, the booster base station 130 may attempt to enter an energy saving mode of the cell C. The overall network load may be, for example, a total load of cells (a first candidate cell and a second candidate cell) overlapping the radio coverage of the capacity booster cell C. The individual threshold value may be, for example, a cell load threshold value assigned to a capacity booster cell. The individual threshold value may be provided by an individual cell base station or management server depending on, for example, a cell arrangement and a terminal distribution. The total threshold value may be, for example, an average (or sum) value of the load threshold values of the first candidate cell and the second candidate cell.

For example, in order to determine whether to enter the energy saving mode, the booster base station 130 may transmit the load information request (Resource State request) to the base stations of the candidate cells A and B. The booster base station 130 may transmit an RSRP information request or a measurement information request further including an RSRP condition. The load information request may be a request further requesting QoS information (e.g., a QoS level) of a terminal satisfying the RSRP condition. The load information request may be, for example, a request for transmitting a load information update (Resource State update) message when there is a terminal satisfying the specified RSRP condition in the capacity booster cell. Hereinafter, an example in which the booster base station 130 determines whether to enter the energy saving mode by considering only the load of the capacity booster cell without considering the overall network load will be described. However, it is not limited thereto.

First, an ES activation (energy saving mode) process of the booster base station 130 will be described.

The booster base station 130 may determine whether the ES activation condition is satisfied on the basis of load information, channel information, and QoS information from at least one of the candidate cell base station (e.g., 120) and the terminal m1 within the capacity booster cell C. The ES activation condition may be, for example, that cell loads (PRB Usage) of the candidate cells are the individual threshold values or less and terminals in each candidate cell are not located within the radio coverage of the capacity booster cell C. In this regard, the booster base station 130 may predict a location of the terminal on the basis of the channel information.

When the ES activation condition is satisfied, the booster base station 130 switches off the capacity booster cell C and enters the ES activation state (the energy saving mode).

The booster base station 130 may confirm that the ES activation condition is not satisfied and an ES standby condition is satisfied on the basis of the received load information, channel information, and QoS information. The ES standby condition may be, for example, that the cell loads (PRB Usage) of the candidate cells are the individual threshold values or less, and at least one terminal of the terminals in the candidate cells have QoS levels that are greater than or equal to a specified level and are located within the radio coverage of the capacity booster cell C. The specified level is a QoS level considered as a high traffic service and may be determined experimentally.

When the ES standby condition is satisfied, the booster base station 130 may initiate an ES inhibit timer. The ES inhibit timer is to prevent a frequent ES ping-pong and may be a timer used to delay ES activation when there is a terminal with a QoS level that is higher than or equal to a specified level in the capacity booster cell C.

When the ES inhibit timer expires, the booster base station 130 may immediately switch to the ES activation state (the energy saving mode) and deactivate (switch off) the capacity booster cell C.

The booster base station 130 may re-determine the operating mode of the capacity booster cell on the basis of the load information, the channel information, and the QoS information, which are received during the operation of the ES inhibit timer. For example, when the booster base station 130 confirms that the ES activation condition is satisfied during the operation of the ES inhibit timer as a specified terminal—with a QoS level that is higher than or equal to a specified level within the capacity booster cell C—moves out of the capacity booster cell C, the booster base station 130 may immediately switch to the ES activation state (the energy saving mode). As another example, when the booster base station 130 confirms that the cell load is higher than or equal to the individual threshold during the operation of the ES inhibit timer, the booster base station 130 may reset the ES inhibit timer and maintain a cell activation mode.

Next, an ES deactivation (cell activation) process of the booster base station 130 will be described.

The booster base station 130 in the energy saving mode may receive a load information update (Resource State Update) message from the candidate cell base station. The load information update message may include candidate cell load information, channel information (RSRP information), and QOS information of a terminal within the candidate cell.

The booster base station 130 may confirm that the ES deactivation condition is satisfied on the basis of the load information update message. The ES deactivation condition may be that the cell load is higher than or equal to an individual threshold, the terminal in the candidate cell is likely to be located within the radio coverage of the capacity booster cell, and the terminal requires a QoS level that is higher than or equal to a specified level.

The booster base station 130 may confirm that an ES deactivation standby condition is satisfied on the basis of the load information update message. The ES deactivation standby condition may be that the cell load is higher than or equal to an individual threshold, the terminal of the candidate cell is likely to be located within the radio coverage of the capacity booster cell, and the terminal requires a QoS level that is less than the specified level.

When the ES deactivation standby condition is satisfied (or when the terminal of the candidate cell does not require a high QoS level), the booster base station 130 may initiate the ES inhibit timer. When the ES inhibit timer expires, the booster base station 130 may activate (switch on) the capacity booster cell C by performing the ES deactivation.

During the operation of the ES inhibit timer, the booster base station 130 may confirm that the cell load is greater than or equal to the individual threshold value or that a terminal with a QoS level that is greater than or equal to a specified level is located within the radio coverage of the capacity booster cell. In this case, the booster base station 130 may reset the ES inhibit timer and switch to the cell activation mode immediately.

Alternatively, during the operation of the ES inhibit timer, the booster base station 130 may confirm that the cell load is maintained below the individual threshold value and the terminal—with the QoS level that is greater than or equal to a specified level—is out of the radio coverage of the capacity booster cell. In this case, the booster base station 130 may reset the ES inhibit timer and maintain the ES activation.

According to various embodiments, the booster base station 130 may receive a cell activation request including ES probing interval information from the candidate cell base station (e.g., 120) in the energy saving mode. When the cell activation request is received, the booster base station 130 may activate the capacity booster cell at least for an ES probing interval. During the ES probing interval, when there is a terminal attempting to be connected or a connected terminal within the radio coverage of the capacity booster cell, the booster base station 130 may perform the ES deactivation.

On the other hand, during the ES probing interval, when there is no terminal attempting to be connected or no connected terminal within the radio coverage of the capacity booster cell, the booster base station 130 may switch to the energy saving mode again. The ES probing interval may be set differently by the candidate cell base station (e.g., 120) depending on, for example, terminal mobility (e.g., a movement speed of at least one terminal within the cell, or a frequency of movement into and out of the cell).

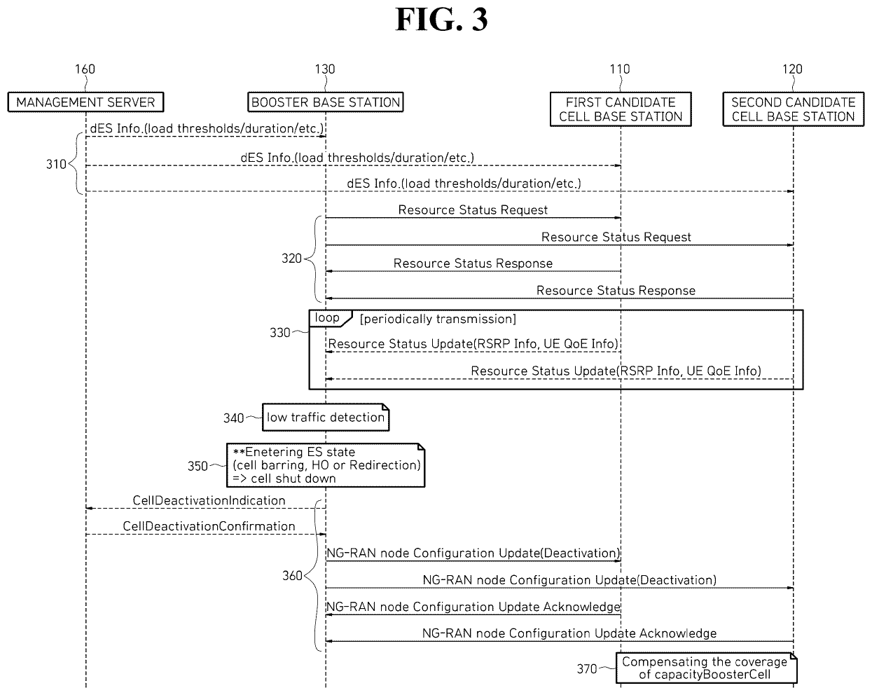

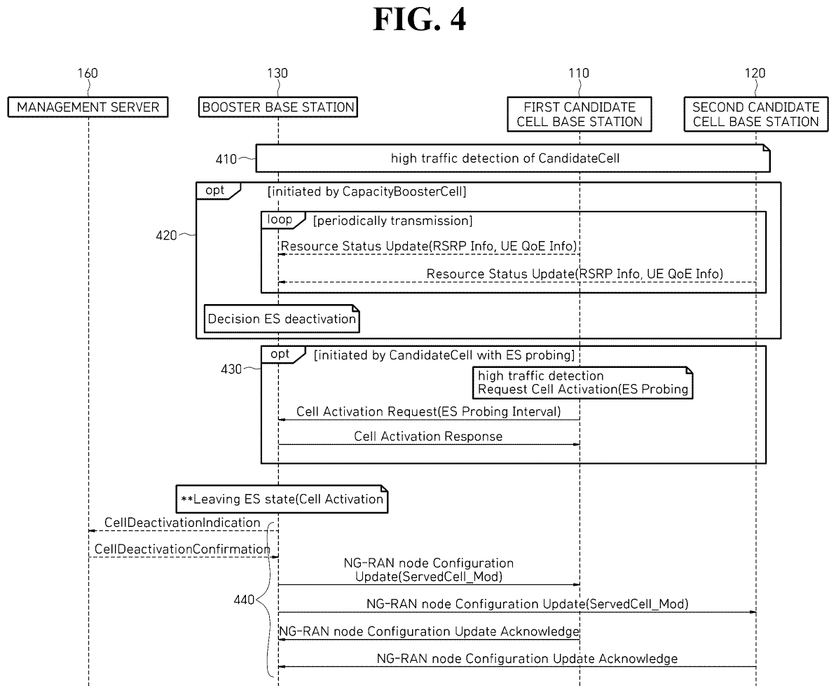

Hereinafter, an ES activation and deactivation process of a mobile communication system according to one embodiment will be described with reference to FIGS. 3 and 4.

The mobile communication system may include a management server 160, a booster base station 130, a first candidate cell base station (e.g., 110), and a second candidate cell base station (e.g., 120). The management server 160 may be a self-organizing network (SON) or operation, administration, and maintenance (OAM) agent responsible for ES control. The booster base station 130 may be a base station managing a capacity booster cell, and the first and second candidate cell base stations 110 and 120 may be base stations managing the first candidate cell and the second candidate cell, respectively.

FIG. 3 is a flowchart illustrating a distributed ES activation process according to one embodiment.

Referring to FIG. 3, in operation 310, the management server 160 may transmit an energy saving algorithm and policy information to the base stations 110, 120, and 130. The energy saving algorithm and the policy information may include, for example, individual threshold value information and duration information of each cell. As another example, the energy saving algorithm and policy information may include an algorithm related to at least one of an energy saving mode, a cell activation mode, an ES activation/deactivation condition, and an ES activation/deactivation standby condition. The individual threshold information may be set equally for all cells or differently for each cell.

In operation 320, the booster base station 130 may transmit load information requests to adjacent cell base stations (e.g., the first and second candidate cell base stations 110 and 120 of FIG. 2) and receive load information responses from the adjacent cell base stations 2). In operation 320, the booster base station 130 may transmit a load information request to cause the adjacent cell base stations 110 and 120 to periodically transmit channel information (RSRP information) and terminal (which are in the adjacent cell) QoS information.

Thus, in operation 330, the booster base station 130 may periodically receive a load information update message including the channel information (RSRP information) and the terminal QoS information. The booster base station 130 predicts load information and terminal location information of the candidate cells on the basis of the load information update message and determines whether to perform the ES activation.

In operation 340, when the booster base station 130 confirms that the ES activation condition is satisfied on the basis of a load information update message from the first and second adjacent cells 110 and 120, in operation 350, the booster base station 130 may switch to the energy saving mode to switch off the capacity booster cell (cell shutdown). For example, when it is confirmed that the cell load is less than the individual threshold value and there is no terminal with a high QoS level within the radio coverage of the capacity booster cell, the booster base station 130 may confirm that the ES activation condition is satisfied.

In operation 350, when the booster base station 130 switches to the energy saving mode, the booster base station 130 may transmit a cell deactivation notification to the management server 160 and the adjacent cell base stations 110 and 120. For example, the booster base station 130 may transmit a cell deactivation notification message to the management server 160 and receive a cell deactivation confirmation message from the management server 160. In addition, the booster base station 130 may transmit a next generation radio access network (NG-RAN) node configuration update to each of the first and second candidate cell base stations 110 and 120. In addition, the booster base station 130 may receive an NG-RAN node configuration update acknowledge from each of the first and second candidate cell base stations 110 and 120.

In the energy saving mode of the capacity booster cell, the first and second adjacent cell base stations 110 and 120 may compensate for the coverage of the capacity booster cell.

FIG. 4 is a flowchart illustrating a distributed ES deactivation process according to one embodiment.

Referring to FIG. 4, in operation 410, the booster base station 130 may detect that a cell load of at least one of the first and second candidate cells 110 and 120 is greater than or equal to the individual threshold value in the energy saving mode. In operation 410, the individual threshold value may be a PRB occupancy rate reference of the capacity booster cell.

In operation 420 or 430, when the booster base station 130 confirms that the ES deactivation condition is satisfied, the booster base station 130 may determine the ES deactivation.

In operation 420, the booster base station 130 may receive a load information update message including RSRP information (RSRP Info) and terminal QoE information (UE QoE Info) from at least one of the first and second candidate cell base stations. When the booster base station 130 predicts that at least one terminal with a high QoE level is located within the capacity booster cell on the basis of the load information update message, the booster base station 130 may determine the ES deactivation.

Alternatively, in operation 430, the booster base station 130 may determine the ES deactivation according to, for example, a cell activation request including ES probing interval information from the first candidate cell base station (e.g., 120). For example, during the ES probing interval included in the cell activation request, the booster base station 130 may activate at least a part of the capacity booster cell and confirm whether there is a terminal attempting to be connected or a connected terminal within the radio coverage of the capacity booster cell. When there is a terminal attempting to be connected or a connected terminal within the radio coverage of the capacity booster cell, the booster base station 130 may determine the ES deactivation. On the other hand, when there is no terminal attempting to be connected or no connected terminal within the radio coverage during the ES probing interval, the booster base station 130 may determine to maintain the energy saving mode (or return to the energy saving mode).

When the ES deactivation is determined in operation 420 or 430, the booster base station 130 may activate the capacity booster cell by switching from the energy saving mode to the cell activation mode.

In operation 440, when the booster base station 130 switches to the cell activation mode, the booster base station 130 may transmit a cell activation notification to the management server 160 and the adjacent cell base stations 110 and 120. For example, the booster base station 130 may transmit a cell activation notification message to the management server 160. As a response, the booster base station 130 may receive a cell activation confirmation message from the management server 160. In addition, the booster base station 130 may transmit an NG-RAN node configuration update to each of the first and second candidate cell base stations 110 and 120. In addition, the booster base station 130 may receive an NG-RAN node configuration update acknowledge from each of the first and second candidate cell base stations 110 and 120.

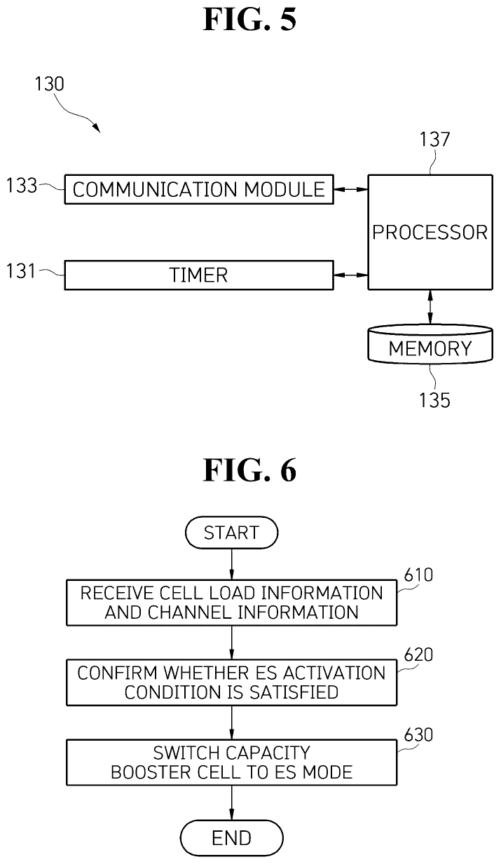

FIG. 5 is a block diagram illustrating a base station device according to one embodiment.

Referring to FIG. 5, the booster base station 130 according to one embodiment may include a timer 131, a communication module 133, a memory 135, and a processor 137. In one embodiment, some components of the booster base station 130 may be omitted or the booster base station 130 may further include additional components. In addition, some of the components of the booster base station 130 may be combined to form a single entity and may perform the same functions of the corresponding components prior to combination. For example, the timer 131 may be included in the processor 137.

The timer 131 may be initiated under the control of processor 137 to measure an elapsed time of a specified period. The timer 131 may be a timer used to delay ES activation in order to prevent a frequent ES ping-pong when there is a terminal using a service quality service that is higher than or equal to a specified level in the capacity booster cell C.

The communication module 133 may support establishment of a communication channel or a wireless communication channel between the booster base station 130 and other devices (e.g., the first and second candidate cell base stations 110 and 120) and communication performance through the established communication channel. The communication channel may include, for example, at least one communication channel of a local area network (LAN), fiber to the home (FTTH), an x digital subscriber line (xDSL), 3G, 4G, and 5G. The communication module 133 may communicate using known communication methods of code division multiple access (CDMA), global system for mobile communications (GSM), wide-CDMA (W-CDMA), time division-synchronous CDMA (TD-SCDMA), wireless broadband Internet (WiBro), long term evolution (LTE), and an evolved packet core (EPC).

The memory 135 may include various forms of volatile memories or non-volatile memories. For example, the memory 135 may include a read only memory (ROM) and a random access memory (RAM). In one embodiment, the memory 135 may be located inside or outside the processor 137, and the memory 135 may be connected to the processor 137 via various parts known in the art.

The memory 135 may store various types of data used by at least one component (e.g., the processor 137) of the booster base station 130. The data may include, for example, software and input data or output data for a command relating to the software. For example, the memory 135 may store at least one instruction and data for base station power management. The at least one instruction, when executed, may cause the processor 137 to receive cell load information and channel information from at least one adjacent cell and at least one terminal within the capacity booster cell through the communication module 133, and to switch to the energy saving mode when it is confirmed that the capacity booster cell satisfies an ES activation condition according to the cell load information and the channel information. The ES activation condition may be that the load of the capacity booster cell is less than the individual threshold value and a specified terminal is not located within the capacity booster cell. In one embodiment, the memory 135 may further store at least one piece of information among an operating mode switching criterion of the booster base station 130 (e.g., the individual threshold value compared to the cell load), specified level information compared to service quality information, and terminal location prediction-related information according to the channel information.

The processor 137 may control at least one other component of the booster base station 130 (e.g., a hardware or software component) and may perform processing or calculation on various types of data. The processor 137 may include, for example, at least one of a central processing unit (CPU), a graphics processing unit (GPU), a microprocessor, an application processor, an application specific integrated circuit (ASIC), and a field programmable gate array (FPGA) and may have a plurality of cores.

According to one embodiment, the processor 137 may receive cell load information and channel information from at least one of the adjacent cell base stations (e.g., the first and second candidate cell base stations 110 and 120 of FIG. 2) and a terminal within the capacity booster cell (e.g., the terminal ml of FIG. 2) through the communication module 133. The cell load information may be, for example, the cell load (PRB Usage) of an adjacent cell. The channel information may include at least one of RSRP, RSRQ, and an SINR of a serving cell and adjacent cells. An example in which the channel information is RSRP information will be described herein. However, it is not limited thereto.

In one embodiment, the processor 137 may further acquire service quality information (e.g., QoS information) that is used by the terminal m1 within the capacity booster cell from at least one of the adjacent cell base station (e.g., 120) or a terminal within the capacity booster cell.

According to one embodiment, the processor 137 may determine an operating mode of the booster base station 130 on the basis of the cell load information, the channel information, and the QoS information. The operating mode may include, for example, the cell activation mode and the energy saving mode. The cell activation mode may be a mode of switching on (activating) the capacity booster cell. The energy saving mode may be, for example, a mode of deactivating (switching off) the capacity booster cell. In the energy saving mode, only some of the components of the booster base station 130 may be activated during a monitoring duration for receiving signals from adjacent cells and the booster base station 130 may be deactivated during the remaining duration.

According to one embodiment, the processor 137 may confirm whether the capacity booster cell satisfies the ES activation condition (first condition) on the basis of the cell load information, the channel information, and the QoS information. The ES activation condition may be that the load of the capacity booster cell is less than the individual threshold value and a specified terminal is not located within the radio coverage of the capacity booster cell. The specified terminal may be a terminal which is using a high-quality service of at least a specified level.

According to one embodiment, when the processor 137 confirms that the capacity booster cell satisfies the ES activation condition, the processor 137 may switch to the energy saving mode. For example, when the load of the capacity booster cell is less than the individual threshold value and there is no terminal which is using a high-quality service of a specified level or higher within the radio coverage of the capacity booster cell, the processor 137 may switch off the capacity booster cell C and switch to the energy saving mode.

According to one embodiment, when the ES standby condition is satisfied (the cell load is less than the individual threshold and a specified terminal is present in the capacity booster cell), the processor 137 may operate the timer 131. For example, when there is a terminal which is using a high-quality service (or a service with high traffic) of a specified level or higher within the capacity booster cell even though the load of the capacity booster cell is less than the individual threshold, the processor 137 may initiate the timer 131, maintain the timer 131 in the cell activation mode, and monitor a cell state. The specified level is a QoS level considered to correspond to a high traffic service and may be determined experimentally.

According to one embodiment, the processor 137 may re-determine the operating mode of the capacity booster cell on the basis of the cell load information, the channel information, and the QOS information, which are received during the operation of the timer 131.

In one embodiment, when the processor 137 determines that the cell load is changed to be greater than or equal to the individual threshold value before the expiration of the timer 131, the processor 137 may maintain the capacity booster cell in the cell activation mode after resetting the timer 131. On the other hand, when the timer 131 expires without any previous condition change, the processor 137 may directly switch to the ES activation state (the energy saving mode) to switch off the capacity booster cell C. Or, when the processor 137 determines that the specified terminal is no longer present within the capacity booster cell before the expiration of the timer 131, the processor 137 may directly switch to the ES activation state after resetting the timer 131.

In one embodiment, the processor 137 may be activated in the energy saving mode during a monitoring duration to track the cell state and determine whether to maintain the energy saving mode. The processor 137 may monitor a load state of the cell and a location of a terminal on the basis of the cell load information and the channel information in the energy saving mode.

According to one embodiment, the processor 137 may receive a load information update (Resource State Update) message from the candidate cell base station during the monitoring duration in the energy saving mode. The load information update message may include candidate cell load information, channel information (RSRP information), and QoS information of the terminal within the candidate cell. For example, the processor 137 may confirm the cell load information, the channel information, and the QoS information on the basis of the load information update message from at least one adjacent cell in the energy saving mode.

The processor 137 may confirm whether at least one adjacent cell satisfies the ES deactivation condition on the basis of the cell load information, the channel information, and the QoS information. The above ES deactivation condition may be, for example, that a load of at least one adjacent cell is greater than or equal to an individual threshold value, a terminal in the candidate cell is predicted to be likely to be located within the radio coverage of the capacity booster cell on the basis of the channel information, and the terminal requires a QoS level that is greater than or equal to a specified level.

When the processor 137 confirms that at least one adjacent cell satisfies the ES deactivation condition, the processor 137 may switch to the cell activation mode.

Alternatively, the processor 137 may confirm that the ES deactivation standby condition is satisfied on the basis of the load information update message. The ES deactivation standby condition may be that the cell load is higher than or equal to an individual threshold, the terminal of the candidate cell is likely to be located within the radio coverage of the capacity booster cell, and the terminal requires a QoS level that is less than the specified level.

In one embodiment, when the ES deactivation standby condition is satisfied (or when a terminal connected to the candidate cell in the capacity booster cell does not require a high QoS level), the processor 137 may initiate the timer 131. When the timer 131 expires without any change in the cell state, the processor 137 may switch to the cell activation mode to switch on the capacity booster cell.

During the operation of the timer 131, the processor 137 may confirm that the cell load is greater than or equal to the individual threshold value or that a terminal with a QoS level that is greater than or equal to a specified level is located within the radio coverage of the capacity booster cell. In this case, the processor 137 may reset the timer 131 and switch to the cell activation mode immediately.

Alternatively, during the operation of the timer 131, the booster base station 130 may confirm that the cell load is maintained below the individual threshold value and the terminal with the QoS level that is greater than or equal to a specified level is out of the radio coverage of the capacity booster cell. In this case, the processor 137 may reset the timer 131 and maintain the energy saving mode.

According to various examples, the processor 137 may receive a cell activation request including ES probing interval information from the candidate cell base station (e.g., 120) in the energy saving mode.

When the cell activation request is received, the processor 137 may activate at least a part of the capacity booster cell at least for the ES probing interval. When there is a terminal (e.g., a handover terminal) attempting to be connected or a connected terminal within the radio coverage of the capacity booster cell during the ES probing interval, the processor 137 may switch to the cell activation mode (perform the ES deactivation) to switch on the capacity booster cell. On the other hand, when there is no terminal attempting to be connected or no connected terminal within the radio coverage of the capacity booster cell during the ES probing interval, the processor 137 may maintain the energy saving mode.

In this way, the booster base station 130 according to one embodiment may reduce power consumption of the base station by activating the capacity booster cell only in a situation in which activation of the capacity booster cell is absolutely necessary (e.g., when traffic of the base station is high and a terminal which is using a high-quality service is present within the capacity booster cell).

In addition, before the booster base station 130 according to one embodiment switches from the cell activation mode to the energy saving mode or switches from the energy saving mode to the cell activation mode, the booster base station 130 delays the mode switching depending on a location of the terminal which is using the high-quality service within the radio coverage of the capacity booster cell, thereby preventing unnecessary activation or deactivation of the energy saving mode. Thus, a signaling overhead and a delay time can be reduced, and an energy saving effect can be increased by reducing the ES ping-pong phenomenon.

In addition, the booster base station 130 according to one embodiment may address the problem of frequent cell activation and deactivation (ping-pong) due to performing cell on/off only with the cell load threshold value according to the related art by further confirming the RSSP information of the terminal within the cell and whether the terminal within the cell uses the high-quality service, in addition to the cell load threshold value (e.g., the individual threshold value).

FIG. 6 is a flowchart illustrating a base station power management method according to one embodiment.

Referring to FIG. 6, in operation 610, the booster base station 130 may receive cell load information and channel information from at least one of at least one adjacent cell and a terminal within the capacity booster cell. The booster base station 130 may further receive QoS information.

In operation 620, the booster base station 130 may confirm whether the capacity booster cell satisfies a first condition depending on the cell load information, the channel information, and the QoS information. The first condition may be that a load of the capacity booster cell is less than an individual threshold value and a specified terminal is not located within the capacity booster cell.

In operation 630, when the booster base station 130 confirms that the capacity booster cell satisfies the first condition, the booster base station 130 switches the capacity booster cell to the energy saving mode.

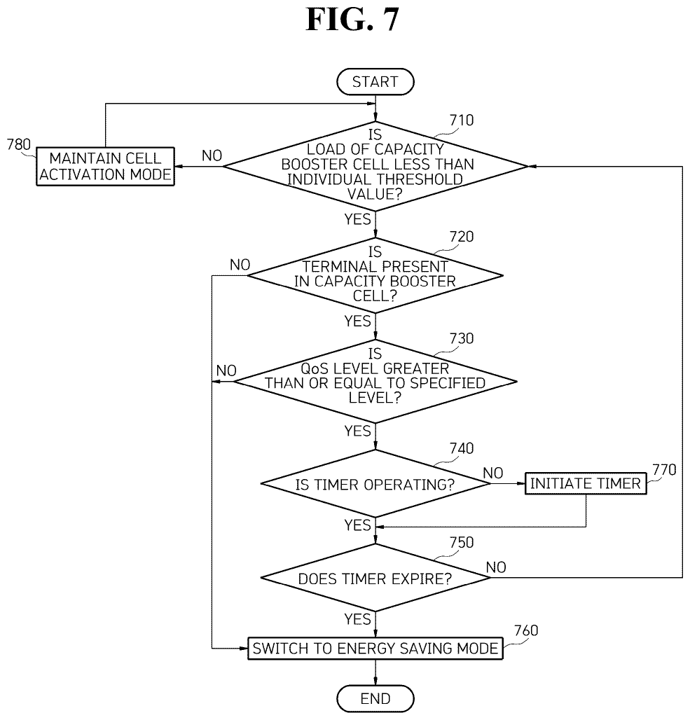

FIG. 7 is a flowchart illustrating a method of entering an energy saving mode according to one embodiment.

Referring to FIG. 7, in operation 710, the booster base station 130 may confirm whether the load of the capacity booster cell is less than the individual threshold value on the basis of the cell load information.

When the booster base station 130 confirms that the load of the capacity booster cell is less than the individual threshold value in operation 710, the booster base station 130 may confirm whether a terminal is located within the radio coverage of the capacity booster cell on the basis of the channel information in operation 720.

When the booster base station 130 confirms that the terminal is located within the radio coverage of the capacity booster cell in operation 720, the booster base station 130 may confirm whether the terminal within the radio coverage of the capacity booster cell is using a high-quality service of a specified level or higher on the basis of the QoS information in operation 730.

When the terminal within the radio coverage of the capacity booster cell is using the high-quality service in operation 730, the booster base station 130 may confirm whether the timer is operating while maintaining the cell activation mode in operation 740.

When the booster base station 130 confirms that the timer 131 is not yet operating in operation 740, the booster base station 130 may initiate the timer 131 in operation 770.

In operation 750, while monitoring whether the timer expires, the booster base station 130 may monitor a cell situation change on the basis of at least one of the cell load information, the channel information, and the QoS information through operations 710 to 730.

When the timer 131 expires with no cell situation change in operation 750, the booster base station 130 may switch to the energy saving mode in operation 760.

The booster base station 130 may monitor a cell situation on the basis of at least one of the cell load information, the channel information, and the QoS information. When the booster base station 130 confirms that the load of the capacity booster cell C is greater than or equal to the individual threshold value during the monitoring of the cell situation, the booster base station 130 may reset the timer and maintain the cell activation mode in operation 780.

The booster base station 130 may confirm that there is no terminal in the capacity booster cell C or that the terminal in the capacity booster cell C is not using a high-quality service on the basis of at least one of the channel information and the QoS information. In this case, the booster base station 130 may reset the timer and switch to the energy saving mode.

When the booster base station 130 confirms that the timer 131 expires in operation 750, the booster base station 130 may switch to the energy saving mode in operation 760.

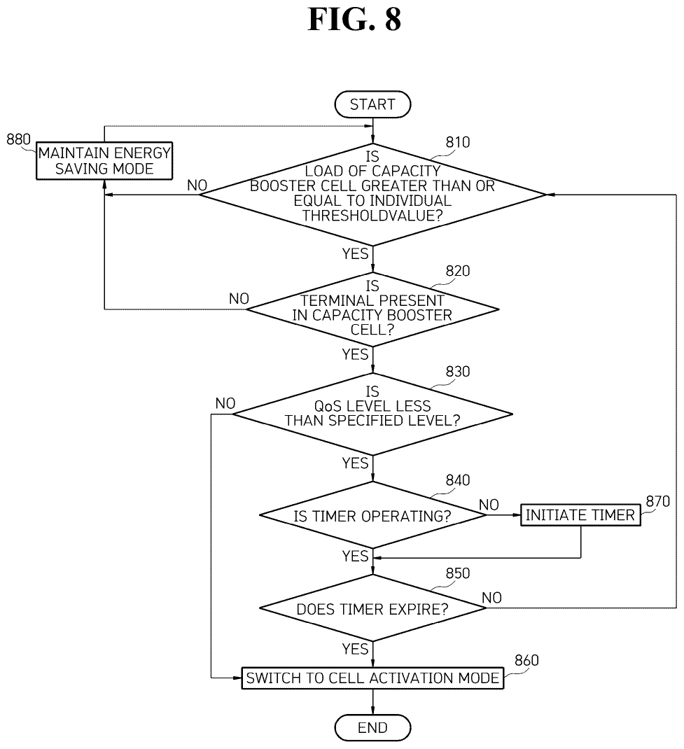

FIG. 8 is a flowchart illustrating a method of deactivating an energy saving mode according to one embodiment.

Referring to FIG. 8, in operation 810, the booster base station 130 may confirm whether the load of the candidate cell is greater than or equal to the individual threshold value on the basis of the cell load information in the energy saving mode.

When the booster base station 130 confirms that the load of the candidate cell is greater than the individual threshold value in operation 810, the booster base station 130 may confirm whether a terminal is located within the radio coverage of the capacity booster cell on the basis of the channel information in operation 820.

When the booster base station 130 confirms that the terminal is located within the radio coverage of the capacity booster cell in operation 820, the booster base station 130 may confirm whether the terminal within the radio coverage of the capacity booster cell is not using a service or whether the service being used is less than a specified level on the basis of the QoS information in operation 830.

When the terminal within the radio coverage of the capacity booster cell is not using a service or the service being used is less than the specified level in operation 830, the booster base station 130 may confirm whether the timer is operating while maintaining the energy saving mode in operation 840.

When the booster base station 130 confirms that the timer 131 is not yet operating in operation 840, the booster base station 130 may initiate the timer 131 in operation 870.

In operation 850, while monitoring whether the timer expires, the booster base station 130 may monitor a cell situation change on the basis of at least one of the cell load information, the channel information, and the QoS information through operations 810 to 830.

When the timer 131 expires with no cell situation change in operation 850, the booster base station 130 may switch to the cell activation mode in operation 860. For example, when the load of the candidate cell is greater than or equal to the threshold value, the QoS level of the terminal in the capacity booster cell is less than the specified level, and the timer expires, the booster base station 130 may switch to the cell activation mode.

When the booster base station 130 confirms that a load of a candidate cell (e.g., B) is less than an individual threshold value or that no terminal is present in the capacity booster cell C while monitoring the cell situation on the basis of at least one of the cell load information and the channel information, the booster base station 130 may reset the timer and maintain the energy saving mode in operation 880.

When the booster base station 130 confirms that the terminal in the capacity booster cell C is using a high-quality service, the booster base station 130 may immediately switch to the cell activation mode in operation 860.

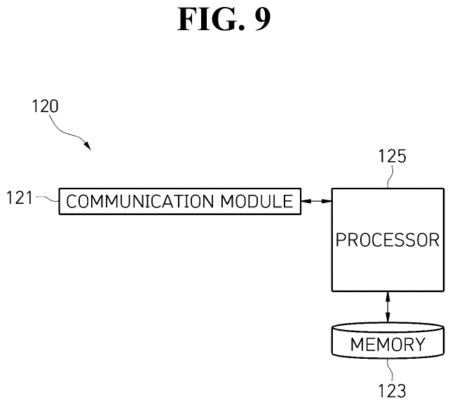

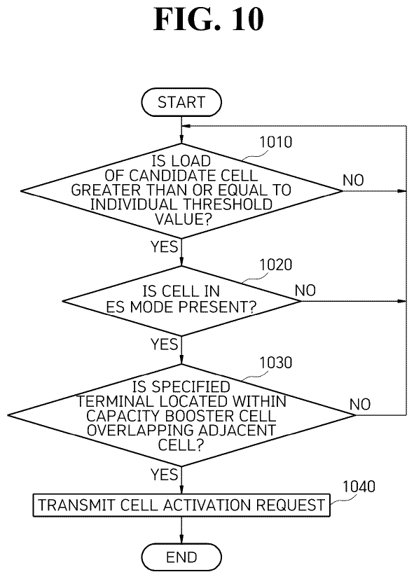

FIG. 9 is a block diagram illustrating a candidate cell base station device according to one embodiment, and FIG. 10 is a flowchart illustrating a power management method by a candidate cell base station according to one embodiment.

Referring to FIG. 9, the candidate cell base station (e.g., 120) according to one embodiment may include a communication module 121, a memory 123, and a processor 125. In one embodiment, some components of the candidate cell base station (e.g., 120) may be omitted or the candidate cell base station (e.g., 120) may further include additional components. In addition, some of the components of the candidate cell base station (e.g., 120) may be combined to form a single entity and may perform the same functions of the corresponding components prior to combination.

The communication module 121 may support establishment of a communication channel or a wireless communication channel between the candidate cell base station (e.g., 120) and another device (e.g., the booster base station 130) and communication performance through the established communication channel. The communication channel may include, for example, at least one communication channel of a LAN, FTTH, an xDSL, 3G, 4G, and 5G. The communication module 121 may communicate using known communication methods of CDMA, GSM, W-CDMA, TD-SCDMA, WiBro, LTE, and an EPC.

The memory 123 may include various forms of volatile memories or non-volatile memories. For example, the memory 123 may include a ROM and a RAM. In one embodiment, the memory 123 may be located inside or outside the processor 125, and the memory 123 may be connected to the processor 125 via various parts known in the art.

The processor 125 may control at least one other component of the candidate cell base station (e.g., 120) (e.g., a hardware or software component) and may perform processing or calculation on various types of data. The processor 125 may include, for example, at least one of a CPU, a GPU, a microprocessor, an application processor, an ASIC, and an FPGA and may have a plurality of cores.

Referring to FIG. 10, in operation 1010, the processor 125 calculates the load within the candidate cell through the communication module 121 and confirms that the load within the candidate cell is greater than or equal to an individual threshold value. The load may be a PRB occupation ratio.

In operation 1020, the processor 125 may confirm whether a capacity booster cell overlapping some region of the candidate cell is in the energy saving mode.

In operation 1020, when the processor 125 confirms that the capacity booster cell overlapping some region of the candidate cell is in the energy saving mode, the processor 125 may confirm whether a specified terminal is located within the corresponding capacity booster cell. The specified terminal may be a terminal which is using at least a high-quality service of a specified level.

In operation 1030, when the specified terminal is located within the capacity booster cell, overlapping some region of the candidate cell, in the energy saving mode, the processor 125 may transmit a cell activation request to a booster base station 130 managing the capacity booster cell. The processor 125 may transmit the cell activation request including an ES probing interval. The processor 125 may set the ES probing interval, for example, on the basis of terminal mobility (e.g., a moving speed of at least one terminal within a cell, or a frequency of movement into and out of the cell) and transmit a cell activation request including information on the set ES probing interval.

In this way, when the capacity booster cell is in the energy saving mode, the candidate cell base station (e.g., 120) according to one embodiment may selectively request the capacity booster cell to be activated for an appropriate amount of time (e.g., the ES probing interval) depending on the load of the cell, the terminal location, or service quality used by the terminal in a situation in which the capacity booster is absolutely necessary. Therefore, energy saving efficiency of the overall base station can be increased and an unnecessary ES ping-pong phenomenon can be prevented.

Various embodiments of the present document and terms used therein are not intended to limit technical characteristics described in the present document to specific embodiments, and it should be understood that the present document includes various modifications, equivalents, or substitutions of the embodiments. In description of drawings, similar reference numerals may be used for similar or associated components. A singular form of a noun corresponding to an item may include one or more items unless the context clearly indicates otherwise. In the present document, expressions such as “A or B,” “at least one of A and B,” “at least one of A or B,” “A, B, or C,” “at least one of A, B, and C” and “at least one of A, B, or C” may include any one of or all possible combinations of items listed together in one of the corresponding expressions. Terms such as “1^{st},” “2^{nd},” “first,” “second,” etc. may be used to simply distinguish a corresponding component from another and do not limit the components in another aspect (e.g., importance or order). When a certain (e.g., first) component is referred to, with or without the term “functionally” or “communicatively,” as “coupled” or “connected” to another (e.g., second) component, it means that the certain component may be coupled with the other component directly (e.g., by wire), wirelessly, or via a third component.

As used herein, the term “module” may include a unit implemented in hardware, software, or firmware and may interchangeably be used with other terms, such as “logic,” “logic block,” “part,” and “circuit.” A module may be a single integral component or a minimal unit or part thereof that performs one or more functions. For example, according to an embodiment, a module may be implemented in the form of an ASIC.

Various embodiments of the present document may be implemented as software (e.g., a program) including one or more instructions that are stored in a storage medium (e.g., an internal memory or an external memory) that is readable by a machine (e.g., an optical wireless communication terminal). For example, a processor (e.g., the first control module 140 of FIG. 2) of a device ((e.g., an optical wireless communication terminal (e.g., the first optical wireless communication terminal 100 of FIG. 2)) may invoke at least one of the one or more stored instructions from the storage medium and execute the at least one invoked instruction. This allows the machine to be operated to perform at least one function in accordance with the at least one invoked instruction. The one or more instructions may include code generated by a compiler or code executable by an interpreter. The machine-readable storage medium may be provided in the form of a non-transitory storage medium. Here, the term “non-transitory” simply means that the storage medium is a tangible device and does not include a signal (e.g., an electromagnetic wave), but this term does not distinguish between a case where data is semi-permanently stored in the storage medium and a case where data is temporarily stored in the storage medium.

According to an embodiment, methods according to various embodiments set forth herein may be included and provided in a computer program product. The computer program product may be traded as a product between a seller and buyer. The computer program product may be distributed in the form of a machine-readable storage medium (e.g., a compact disc (CD) read-only memory (ROM)) or distributed (e.g., downloaded or uploaded) online via an application store (e.g., PlayStore™) or between two user devices (e.g., smartphones) directly. When distributed online, at least a part of the computer program product may be temporarily generated or at least temporarily stored in a machine-readable storage medium such as a memory of the manufacturer's server, an application store server, or a relay server.

Components according to various embodiments of the present document may be implemented in the form of software or hardware, such as a digital signal processor (DSP), an FPGA, or an ASIC and perform certain roles. The term “components” is not limited to software or hardware, and each component may be configured to be in an addressable storage medium or to reproduce one or more processors. Examples of components may include components, such as software components, object-oriented software components, class components, and task components, processes, functions, attributes, procedures, subroutines, segments of a program code, drivers, firmware, microcode, circuits, data, databases, data structures, tables, arrays, and variables.

According to various embodiments, each (e.g., a module or a program) of the foregoing components may include a single entity or a plurality of entities. According to various embodiments, one or more of the foregoing components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same manner as or a similar manner to a corresponding one of the plurality of components prior to the integration. According to various embodiments, operations performed by a module, a program, or another component may be carried out sequentially, in parallel, repeatedly, or heuristically, one or more of the operations may be executed in a different order or omitted, or one or more other operations may be added.

According to various embodiments disclosed in the present document, it is possible to enhance security of optical communication due to an adaptive optical polarization state. In addition, various effects that are directly or indirectly understood from the present document can be provided.

In accordance with various embodiments of the present disclosure, the embodiment can dynamically manage base station energy saving depending on channel conditions. In addition, various effects can be provided that are directly or indirectly identified through the present disclosure.

What is claimed is:

1. A base station device for managing a capacity booster cell for increasing a communication channel in some region of at least one adjacent cell, the base station device comprising:
a communication module configured to provide a communication channel to the capacity booster cell corresponding the some region; and
a processor functionally connected to the communication module,
wherein the processor:
receives cell load information and channel information from the at least one adjacent cell and at least one terminal within the capacity booster cell through the communication module;
confirms that the capacity booster cell satisfies a first condition according to the cell load information and the channel information, wherein the first condition is that a load of the capacity booster cell is less than a specified threshold value, and a specified terminal is not located within the capacity booster cell; and
switches to an energy saving mode when the capacity booster cell satisfies the first condition.

2. The base station device of claim 1, wherein, when the specified terminal which is using a high-quality service of at least a specified level is present within the capacity booster cell, the processor delays switching to the energy saving mode.

3. The base station device of claim 2, wherein, the processor receives service quality information from the at least one adjacent cell and the at least one terminal and confirms whether at least one terminal is the specified terminal on the basis of the service quality information.

4. The base station device of claim 1, wherein, when the load of the capacity booster cell is less than the specified threshold value and the specifiedspecified terminal is not present in the capacity booster cell, the processor operates a timer to delay the switching to the energy saving mode.

5. The base station device of claim 4, wherein, when the first condition is satisfied before the timer expires, the processor resets the timer and then switches to the energy saving mode.

6. The base station device of claim 4, wherein, when the load of the capacity booster cell is changed to the specified threshold value or more before the timer expires, the processor resets the timer and then maintains activation of the capacity booster cell.

7. The base station device of claim 4, wherein, when the timer expires in a state in which the first condition is satisfied, the processor switches to the energy saving mode.

8. The base station device of claim 1, wherein, when a cell activation request of the at least one adjacent cell is received in the energy saving mode, the processor activates at least a portion of the capacity booster cell for a specified activation duration included in the cell activation request.

9. The base station device of claim 8, wherein, when a terminal attempting to be connected or a connected terminal to the capacity booster cell is present during the specified activation duration, the processor switches from the energy saving mode to the cell activation mode.

10. The base station device of claim 8, wherein, when a terminal attempting to be connected or a connected terminal to the capacity booster cell is not present during the specified activation duration, the processor switches to the energy saving mode again.

11. The base station device of claim 1, wherein the processor:
confirms whether the at least one adjacent cell satisfies a second condition on the basis of load information of another cell, other channel information, and other service quality information from the at least one adjacent cell in the energy saving mode; and
switches to a cell activation mode when it is confirmed that the at least one adjacent cell satisfies the second condition.

12. The base station device of claim 11, wherein the second condition is that a load of the at least one adjacent cell is greater than or equal to the specified threshold value, and the specified terminal is predicted to be located within the capacity booster cell.

13. The base station device of claim 11, wherein, the processor delays switching to the cell activation mode when the load of the at least one adjacent cell is greater than or equal to the specified threshold value or a terminal within the capacity booster cell is predicted to not be the specifispecified terminal, on the basis of load information of another cell, other channel information, and other service quality information from the at least one adjacent cell in the energy saving mode.

14. A base station energy saving method of managing a capacity booster cell for increasing a communication channel in some region of at least one adjacent cell, the base station energy saving method comprising:
receiving cell load information and channel information from the at least one adjacent cell and at least one terminal within the capacity booster cell;
confirming that the capacity booster cell satisfies a first condition according to the cell load information and the channel information, wherein the first condition is that a load of the capacity booster cell is less than a specified threshold value, and a specified terminal is not located within the capacity booster cell; and
when it is confirmed that the capacity booster cell satisfies the first condition, switching the capacity booster cell to an energy saving mode.

15. The base station energy saving method of claim 14, further comprising, when the specified terminal which is using a high-quality service of at least a specified level is present within the capacity booster cell, delaying the switching to the energy saving mode.

16. The base station energy saving method of claim 14, further comprising, when a cell activation request of the at least one adjacent cell is received in the energy saving mode or it is confirmed that a second condition related to deactivation of the energy saving mode is satisfied on the basis of information received from the at least one adjacent cell, switching to a cell activation mode.

17. The base station energy saving method of claim 16, wherein the switching to the cell activation mode includes:
when the cell activation request is received, activating at least a portion of the capacity booster cell for a specified activation duration included in the cell activation request; and
performing switching to the cell activation mode or switching to the energy saving mode again on the basis of whether another terminal attempting to be connected or another connected terminal to the capacity booster cell is present during the specified activation duration.

18. The base station energy saving method of claim 16, wherein the switching to the cell activation mode includes:
confirming whether the at least one adjacent cell satisfies a second condition on the basis of load information of another cell, other channel information, and other service quality information from the at least one adjacent cell in the energy saving mode;
switching to the cell activation mode when it is confirmed that the at least one adjacent cell satisfies the second condition; and
when a load of the at least one adjacent cell is less than the specified threshold value or when a terminal in the capacity booster cell is predicted to not be the specified terminal, delaying the switching to the cell activation mode.

19. A base station device for managing a candidate cell of which some region overlaps a capacity booster cell for increasing a communication channel, the base station device comprising:
a communication module configured to provide a communication channel in the candidate cell; and
a processor functionally connected to the communication module,
wherein the processor:
calculates a load in the candidate cell through the communication module;
confirms whether the capacity booster cell overlapping the some region of the candidate cell is in an energy saving mode when the load in the candidate cell is greater than or equal to a specified threshold value; and
transmits a cell activation request to a base station of the capacity booster cell when a specified terminal is located within the capacity booster cell.

20. The base station device of claim 19, wherein the processor transmits the cell activation request including an ES probing interval in response to a presence of the specified terminal which is using a high quality service of at least a specified level.
